(19) United States
(12) Patent Application Publication
(10) Pub. No.: US 2025/0229497 A1
(43) Pub. Date: Jul. 17, 2025

(54) ROOT INSERT STOPPER FASTENING EQUIPMENT

(71) Applicant: TPI Technology, Inc., Scottsdale, AZ (US)

(72) Inventors: Özgur Isler, Izmir (TR); Özer Onurlu, Izmir (TR)

(21) Appl. No.: 19/028,700

(22) Filed: Jan. 17, 2025

Related U.S. Application Data
(60) Provisional application No. 63/621,802, filed on Jan. 17, 2024.

(51) Int. Cl. B29C 70/02; B29C 70/54; B29K 705/00; B29L 31/08; F03D 13/00

(52) U.S. Cl. CPC B29C 70/023; B29C 70/54; F03D 13/00; B29K 2705/00; B29L 2031/085; F05B 2230/60

(57) ABSTRACT

A system for inserting a stopper in a metal root insert, the system comprising a chassis, the chassis having a bottom plate, a pillar extending perpendicularly therefrom to a second end, at least one strut having a first end and a top cover disposed at the second end of the at least one strut, the top cover disposed perpendicularly to the bottom plate, an absorber clamp extending perpendicular to the pillar, the absorber clamp having a circular bearing configured to hingedly close, a top clamp disposed at the second end of the pillar, and having a cylindrical bearing configured to vertically translate relative to the top clamp, a piston disposed below the top cover and configured to translate vertically through at least one of the bottom plate and the top cover and a limit switch operatively coupled to piston, the limit switch configured to detect a travel of the piston.

### CROSS REFERENCE TO RELATED APPLICATION

This application claims the benefit of priority under 35 USC 119 to the Provisional patent application No. 63/621,802 filed Jan. 17, 2024; the entire contents of which are hereby incorporated by reference.

### FIELD OF THE DISCLOSED SUBJECT MATTER

The disclosed subject matter relates to inserting a stopper in a metal insert. Particularly, the present disclosed subject matter is directed to systems and methods for inserting a stopper in a metal insert in the root portion of a composite wind turbine blade.

### BACKGROUND OF THE DISCLOSED SUBJECT MATTER

A metal insert is used to carry the weight of the blade in a composite wind turbine blade assembly and is used during assembly of the studs in the composite wind turbine system, e.g., in attaching the blade to the nacelle. A stopper is usually inserted into the metal root insert but is not visually assessable/detectable by human technicians. If the stopper is incorrectly positioned within the root insert, resin may ingress into the root insert during one or more resin transfer processes such as vacuum assisted resin transfer molding (VARTM). Should resin enter the root insert, it may lead to broken studs, obstruction of hardware component, and other mechanical failures. Additionally, should the stopper be incorrectly positioned within the root insert it may lead to position errors in the fixture studs in the finish mold area and core positioning inside the fixture stud during insertion.

Conventional methods for inserting the stopper in the metal insert include a technician or operator manually applying force with their arm to insert the stopper in the metal insert. This conventional method may lead to user error, increased time for assembly among mechanical damage and positioning errors during assembly as well as personal injury. Conventional methods may take up to 2.5 standard shifts to complete insertion of stoppers in a full set of metal inserts.

Therefore, there is a need for a systems and methods for accurately and repeatably inserting stoppers in a root metal insert for composite wind turbine blade assemblies.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes A system for inserting a stopper in a metal root insert, the system comprising a chassis, the chassis having a bottom plate having a first end and a second end, defining a length therebetween, the chassis having generally planar a top surface and a bottom surface defining a thickness therebetween, the chassis further having a pillar having a first end disposed on the first side of the top surface of the bottom plate and extending perpendicularly therefrom to a second end at least one strut having a first end disposed on the second side of the top surface of the bottom plate and extending perpendicularly therefrom to a second end, a top cover disposed at the second end of the at least one strut, the top cover disposed perpendicularly to the bottom plate, an absorber clamp disposed on the pillar, the absorber clamp extending perpendicular to the pillar, the absorber clamp having a circular bearing configured to hingedly close, a top clamp disposed at the second end of the pillar, the top clamp having a cylindrical bearing configured to vertically translate relative to the top clamp, a piston disposed below the top cover, the piston configured to translate vertically through at least one of the bottom plate and the top cover and a limit switch operatively coupled to piston, the limit switch configured to detect a travel of the piston.

In some embodiments, the top cover further comprises a bottom insert rest disposed on a top surface thereof, the bottom insert rest having a cylindrical alignment feature.

In some embodiments, the absorber clamp comprises at least one sensor.

In some embodiments, the at least one sensor is configured to detect the presence of a metal root insert.

In some embodiments, the at least one sensor is configured to detect closure of the absorber clamp.

In some embodiments, the chassis further comprises an alignment bearing, the alignment bearing extending from the pillar and having a semicircular bearing configured to contact a cylindrical sidewall of the metal root insert.

In some embodiments, wherein the metal root insert comprises a first end and a second end with a cylindrical sidewall extending therebetween, the metal root insert further comprising an outer diameter and an inner diameter, defining a cylindrical thickness therebetween.

In some embodiments, wherein the at least one strut comprises four struts, the four struts equiaxially spaced proximate the second end of the bottom plate, the at least four struts each having a first end disposed on the top surface of the bottom plate and a second end disposed on a bottom surface of the top cover.

In some embodiments, the bottom plate comprises an opening extending from the bottom surface to the top surface, the opening sized to receive the piston.

In some embodiments, the top cover comprises an opening axially aligned with the opening in the bottom plate, the opening in the top cover extending through the bottom insert rest.

In some embodiments, the stopper comprises a first end and a second end, with a cylindrical sidewall therebetween, the stopper further comprising an outer diameter approximately equal to the inner diameter of the metal root insert.

In some embodiments, the stopper is formed from a plastic material.

In some embodiments, the metal root insert is formed from one or more metals or metal alloys.

In some embodiments, the metal root insert is formed from steel.

The disclosed subject matter also includes a method for inserting a stopper in a metal root insert, the method comprising: loading a stopper onto a piston circumscribed by a bottom insert rest; loading a first end of a metal root insert onto a bottom insert rest over the stopper such that the stopper is disposed within a hollow interior of the first end of the metal root insert; clamping the metal root insert to a chassis pillar, wherein clamping the metal root insert comprises closing and latching an absorber clamp about a cylindrical sidewall of the metal root insert and closing a top clamp over a second end of the metal root insert; actuating the piston having the stopper to a position within the hollow interior of the metal root insert; detecting the position of the stopper based on a travel of the piston; displaying a position datum of the stopper; and removing the metal root insert within the positioned stopper from the chassis.

In some embodiments, detecting the position of the stopper based on a travel of the piston comprises detecting the travel between a rest position of the piston and an end position of the piston.

In some embodiments, displaying the position datum of the stopper comprises illuminating at least one light source.

In some embodiments, illuminating the at least one light source comprises illuminating at least one light source to display a proper positioning of the stopper within the metal root insert.

In some embodiments, displaying a position datum comprises producing an audible signal to a user.

In some embodiments, removing the metal root insert comprises retracting the piston from within the metal root insert.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIGS. 1-2D are schematic representations of the system for inserting the stopper in a metal root insert in accordance with the disclosed subject matter.

FIG. 2E is a partial schematic representation of the system for inserting the stopper in a metal root insert in accordance with the disclosed subject matter.

FIG. 2F is a top schematic representation of visual indicators of the system for inserting the stopper in a metal root insert in accordance with the disclosed subject matter.

FIGS. 3A and 3B is schematic detail view of a top clamp in accordance with the disclosed subject matter.

FIGS. 4A and 4B is schematic detail view of an absorber clamp in accordance with the disclosed subject matter.

FIG. 5 is a schematic detail view of the top cover and bottom insert rest of the chassis in accordance with the disclosed subject matter.

FIG. 6 is a schematic detail view of the bottom insert rest with piston extending therethrough in accordance with the disclosed subject matter.

FIG. 7 is a schematic detail views of the stopper in accordance with the disclosed subject matter.

FIG. 8 is a schematic detail view of the piston extending from the bottom plate to the top cover through the linear bearing and a limit switch in accordance with the disclosed subject matter.

FIG. 9 is a method for inserting a stopper in a metal root insert in accordance with the disclosed subject matter.

### DETAILED DESCRIPTION OF AN EXEMPLARY EMBODIMENT

Reference will now be made in detail to exemplary embodiments of the disclosed subject matter, an example of which is illustrated in the accompanying drawings. The method and corresponding steps of the disclosed subject matter will be described in conjunction with the detailed description of the system.

The methods and systems presented herein may be used for inserting stoppers in metal root inserts of composite wind turbine blade assemblies. An exemplary wind turbine blade root assembly is disclosed in U.S. Pat. No. 12,006,908, the entirety of which is hereby incorporated by reference.

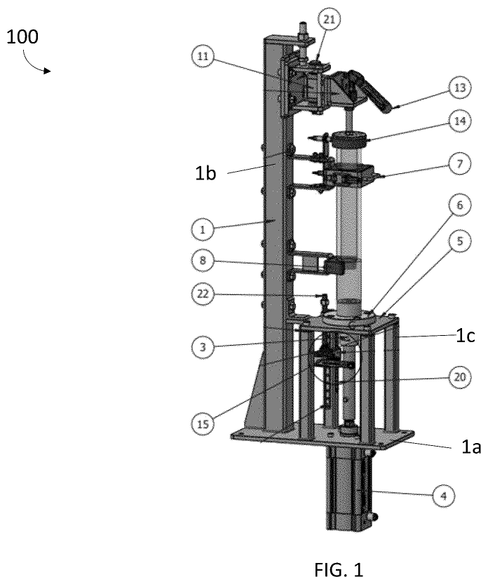

The disclosed subject matter is particularly suited for accurately, repeatably and increasing speed of insertion of stoppers in metal root inserts for composite wind turbine blade assemblies where visual assessment of the stopper position within the root insert is not possible or quickly attainable by technicians or operators. For purpose of explanation and illustration, and not limitation, an exemplary embodiment of the system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

The metal root insert as described herein may be a generally right cylinder having circular planar ends, defining an axis therebetween and having a cylindrical sidewall extending therebetween. The metal root inserts may include an outer diameter and an inner diameter, defining a thickness therebetween. In various embodiments the metal root insert may have a constant inner diameter along its length. In various embodiments, the metal root insert may include a variable (e.g., stepped) inner diameter along its length such as to define or more internal shoulders where the inner diameter decreases or increases. In various embodiments, the internal shoulders may be instantaneous, thus defining a right angle shoulder within the metal root insert. In various embodiments, the inner diameter may taper or gradually change over a certain length of the metal root insert, thus defining a conical interior surface between the smaller and larger inner diameters of the metal root insert.

The metal root insert may require a stopper to be inserted within the inner diameter at some point along its length. The stopper may be formed from one or more metals, plastics, composites or other materials. In various embodiments, the stopper may be configured to contact the full inner circumference of the metal root insert or a portion thereof. In various embodiments the stopper may be a generally right cylindrical component having a diameter approximately equal to the inner diameter of the metal root insert and configured to be coupled thereto via a press fit. In various embodiments, the stopper may be configured to abut one or more internal shoulders of the metal root insert with its circular end. The stopper and metal root insert are consumable materials and configured to be coupled via the system described herein. The metal root insert and stopper therefore may constitute a portion of the system 100 and are denoted as metal root insert 104 and stopper 108 where appropriate.

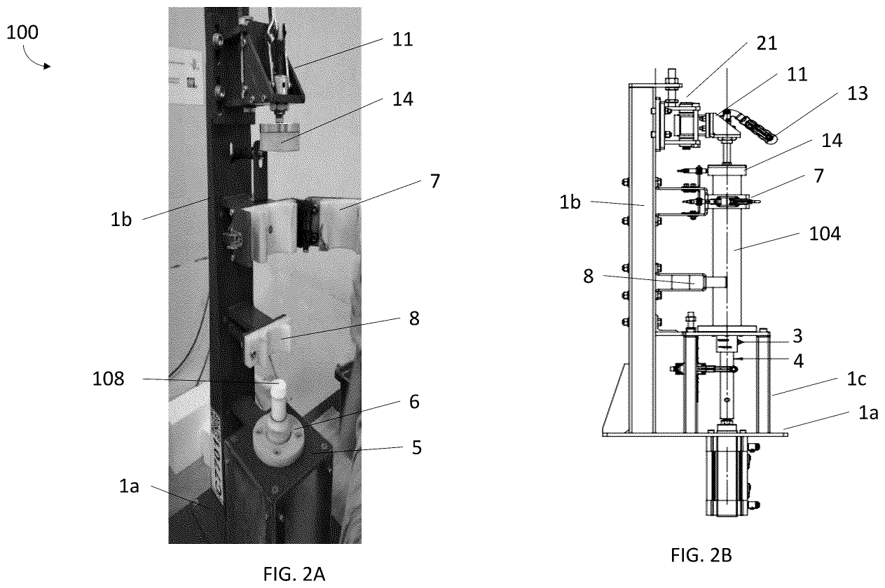

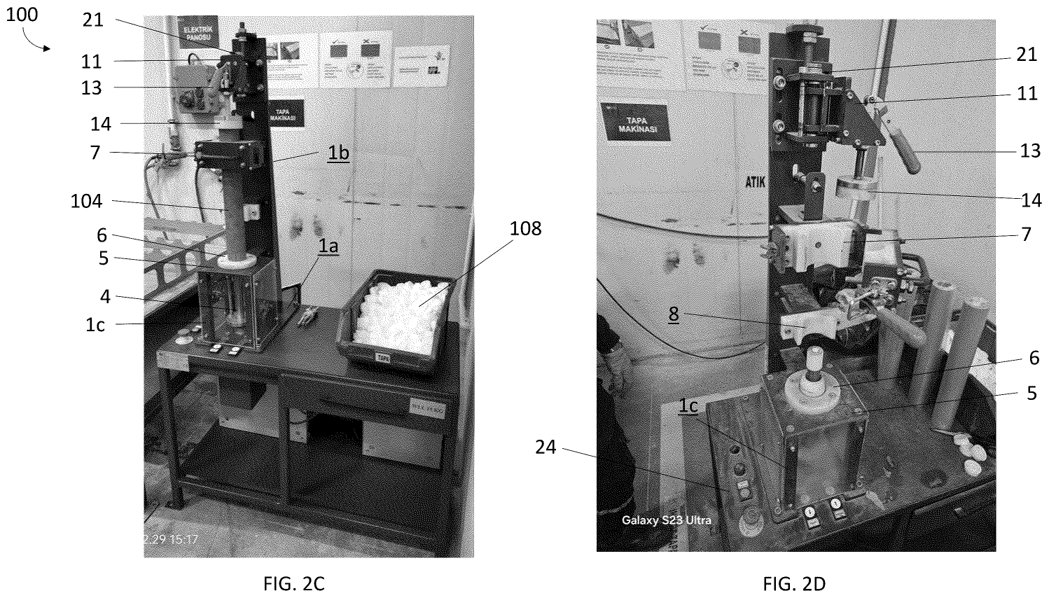

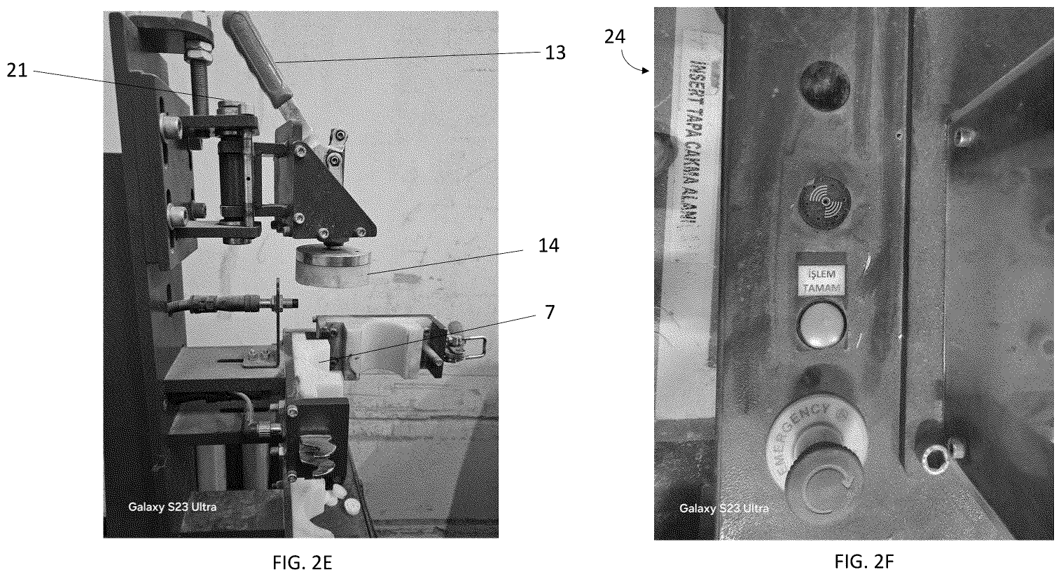

As shown in FIG. 1, the system 100 for root insert stopper fastening is shown in a perspective view. Alternate views of system 100 can be seen in FIGS. 2A-2D. System 100 includes a chassis 1. Chassis 1 may include a generally planar bottom plate 1a having a generally rectilinear planform construction, and oriented perpendicular to the chassis with the chassis positioned on the left side of the plate. The bottom plate 1a may be rectangular, square, oblong, circular or any other polygonal planform shape of sufficient dimension to provide stability to the Chassis 1 during operation of the system 100. The bottom plate 1a of chassis 1 may include a thickness extending from a top surface to a bottom surface. The bottom plate 1a of chassis 1 may include a first end and a second end, defining a length therebetween. The bottom plate 1a of chassis 1 may include a lateral width perpendicular to the length.

Chassis 1 may include a pillar 1b extending from the top surface of the bottom plate 1a and extending a height above the bottom plate 1a. The pillar 1b may be disposed at one end of the bottom plate 1a and extend perpendicularly from said bottom plate 1a. The pillar 1b may be spaced from the edge of bottom plate 1a and have one or more support struts, fins or flanges extending therefrom to improve stability of the chassis and retain the pillar 1b in said perpendicular arrangement to the bottom plate 1a. The pillar 1b may be unitarily constructed with the bottom plate 1a or be affixed thereto, such as chemical adhesion or welding, in various embodiments. The pillar 1b may extend any height above the bottom plate 1a and have any number of holes, flanges, channels, shoulders or other geometrical features configured to affix one or more other components to the pillar 1b.

Chassis 1 may further include a plurality of struts 1c extending from the top surface of the bottom plate 1a parallel to the pillar 1b. The plurality of struts 1c may be disposed on the opposite end of the bottom plate 1a from the pillar 1b. The plurality of struts 1c may be equiaxially spaced about a central point on the bottom plate 1a. The plurality of struts 1c may be 2, 3, 4 or more struts 1c extending from the bottom plate 1a. In various embodiments, each strut 1c of the plurality of struts may extend from the top surface of the bottom plate 1a to a cylinder connection top cover 5.

In various embodiments, each strut 1c of the plurality of struts may be coupled to one or more protective shields extending therebetween. For example and without limitation, transparent plastic, plexiglass, safety glass or other transparent sheets may be affixed to each strut 1c of the plurality of struts in order to seclude the piston 4 from the operator or technician. In various embodiments, these shields may extend between every strut forming a box between the top cover 5 and the bottom plate 1a of the chassis 1. In various embodiments, each shield may extend partially between each strut and the top cover 5 and the bottom plate 1a. In various embodiments, one or more shields may be hingedly coupled to at least one strut such that an operator may gain access to the piston 4 during a depowered period or between operations for maintenance or adjustment purposes.

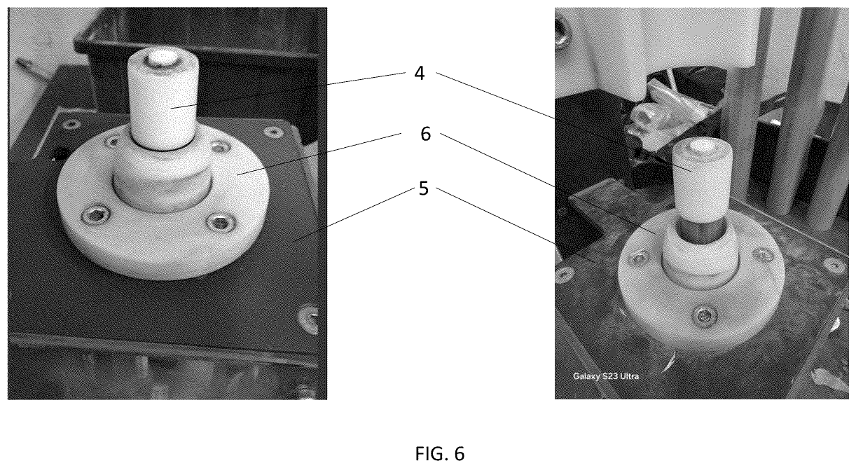

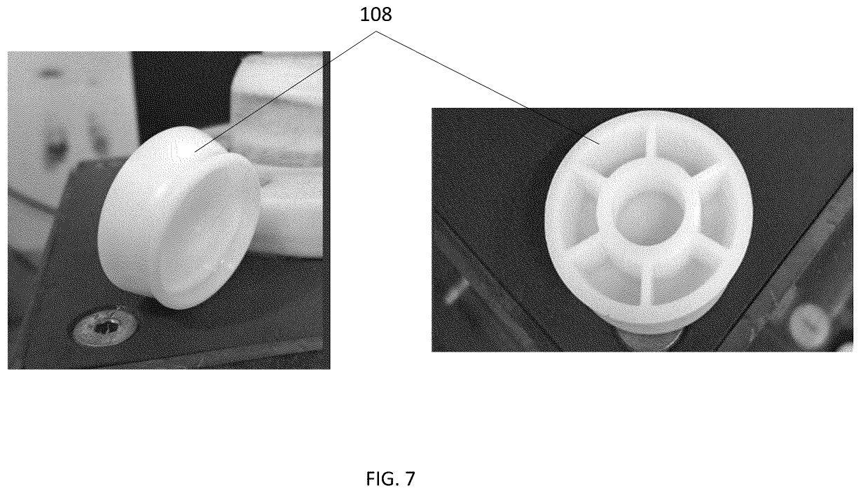

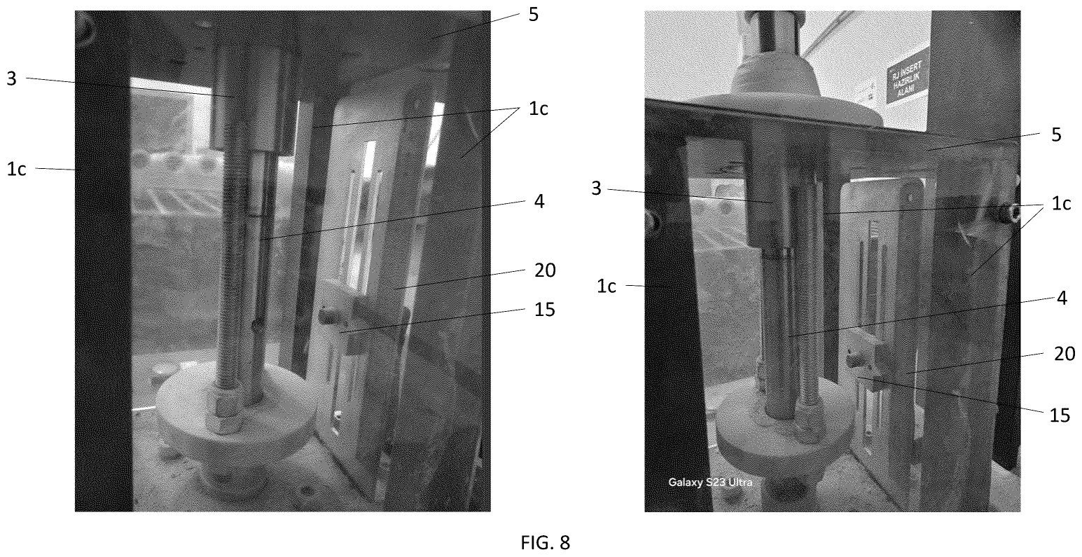

The top cover 5 may be a generally planar plate having rectilinear edges, the top cover 5 disposed parallel to the bottom plate 1a and spaced therefrom. In various embodiments, the plurality of struts 1c may be formed as a unitary structure with the bottom plate 1a or affixed thereto in any manner described herein. In various embodiments, the top cover 5 may be affixed to each of the plurality of struts 1c via one or more mechanical fasteners, such as bolts, screws or the like. Top cover 5 may include one or more openings disposed therethrough, for example centrally located in the top cover 5 and extending through the thickness of the top cover 5. In various embodiments, top cover 5 may include a bottom insert rest 6 disposed thereon. Insert bottom rest 6 may be disposed about the opening within top cover 5. Insert bottom rest 6 may be circular with a cylindrical aligning feature axially disposed therein. The insert bottom rest 6 may be configured to align the metal root insert on the top cover 5 during operation as shown in FIGS. 5 and 8. The bottom insert rest 6 may include a generally planar portion having a centrally disposed boss. The centrally disposed boss may have an outer diameter approximately equal to the inner diameter of the metal root insert 104 and configured to align the metal root insert 104 as a piston 4 translates from below the top cover 5, up through the root metal insert disposed thereon, as will be described herein below. The top portion of piston 4 is configured to translate through the bottom insert rest 6 as shown in FIG. 6.

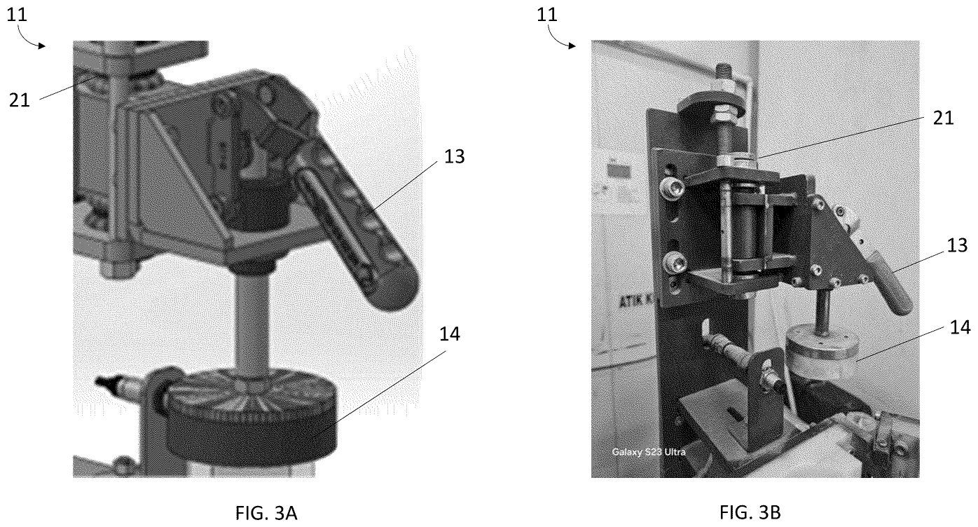

With continued reference to FIGS. 1-2D, system 100 may include a top clamp 11. A close-up detail view of the top clamp 11 can be seen in FIGS. 3A and 3B. The top clamp 11 is configured to retain the cylindrical end of the metal root insert during operation. Top clamp 11 may be affixed to the pillar 1b of chassis 1 via one or more mechanical fasteners and extend laterally from the pillar 1b. The top clamp 11 may be lever actuated, such that in a first open position, the clamp is retracted upward to allow for insertion of the metal root insert and is configured to be closed upon the metal root insert by actuating the lever to a second closed position, thereby exerting a longitudinal force to compress the metal root insert against the top cover 5 and insert bottom rest 6 thereby retaining the metal root insert between the top clamp 11 and the top cover 5. The top clamp 11 may include a cylindrical polyurethane bearing 14 actuatably coupled to the lever that is configured to translate longitudinally in response to the lever position. The polyurethane bearing 14 may be configured to envelope the cylindrical end of the metal root insert's end and wrap around the cylindrical sidewall thereof. The polyurethane bearing 14 under compression from the top clamp 11 therefore both retains the root metal insert in position for stopper insertion but also aligns the root metal insert in proper position for stopper insertion.

In various embodiments, top clamp 11 may include a pin 21. Top clamp 11 may be rotatably fixed to pillar 1b via the pin 21. Top claim 11 may be configured to rotate about the axis of the pin 21, wherein the axis of the pin 21 is parallel to the pillar 1b. Top clamp 11 may be configured to rotate about the pin 21 in order to remove the clamp from the area proximal the clamps in order to make way for loading the metal root insert 104 into the system 100. In various embodiments, top clamp 11 may be configured to rotate in either direction relative to the pillar 1b. In various embodiments, top clamp 11 may be configured to only rotate in a single direction.

With continued reference to FIG. 1-2D, system 100 may include one or more alignment bearings 8 extending perpendicularly from the pillar 1b to at least partially contact the cylindrical sidewall of the metal root insert in order to align and support said metal root insert in the system 100 for insertion of the stopper. The one or more alignment bearing 8 may include polyurethane bearings having complementary geometry configured to contact the cylindrical sidewall of the metal root insert, such as 180 degrees of the metal root insert. The at least one alignment bearings 8 may be adjustable such that the distance from the pillar 1b can be adjusted to accommodate metal root inserts of various dimensions, such as increased or decreased radiuses.

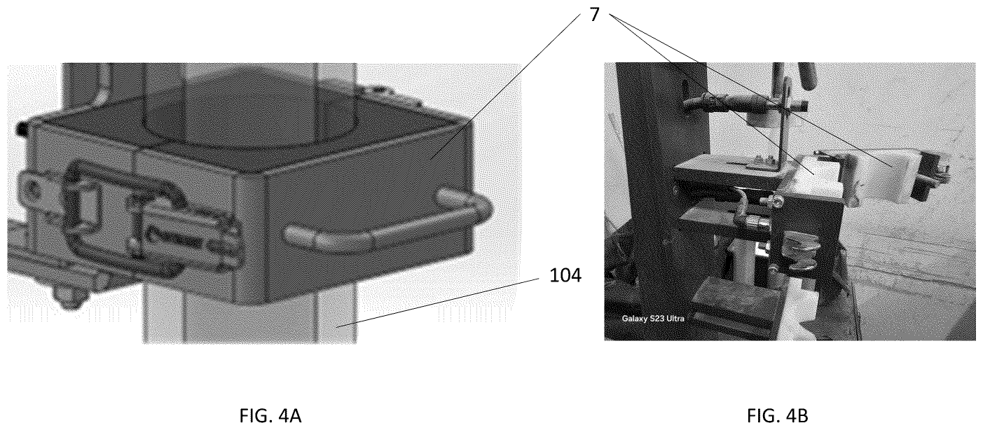

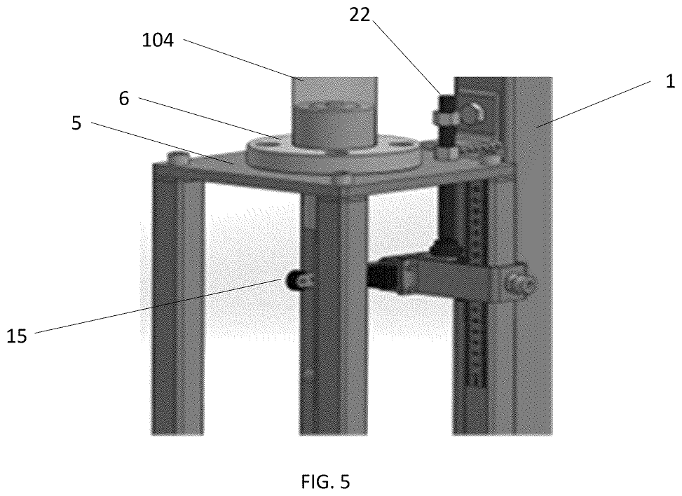

With continued reference to FIGS. 1-2D, system 100 may include one or more absorber clamps 7. The absorber clamp(s) 7 may be configured to contact and wrap (partially or entirely) around the cylindrical sidewall of the metal root insert. The absorber clamp 7 may be clamped via one or more latches or other mechanical fasteners and is configured to retain the vertical alignment of the metal root insert during insertion of the stopper therein. A close-up detailed view of absorber clamp 7 can be seen in FIGS. 4A and 4B. The absorber clamp may be affixed to the pillar 1b of the chassis 1 and extends therefrom laterally in order to contact the metal root insert. In various embodiments the absorber clamp 7 is adjustably fixed to the pillar 1b of the chassis 1 such that the absorber clamp 7 can accommodate various radii of metal root inserts. The absorber clamp 7 may similarly be adjusted to accommodate said radii of metal root inserts, such as with elastic or deformable openings or swappable clamping surfaces configured to be switched in and out corresponding to the size of metal root insert. For example, the absorber clamp 7 may include flexible materials, such as elastomers or spring-loaded components, that can adapt to the radius of the metal root insert. The swappable clamping surfaces may be formed of a rigid material. The absorber clamp 7 may include a screw-driven mechanism, a gear mechanism, and/or a belt and pulley mechanism. The absorber clamp 7 may include a linear actuator, hydraulic actuator, and/or pneumatic actuator. The absorber clamp 7 may include vibration dampeners such as rubberized coatings, rubber, elastomers, or shock absorbing components. The absorber clamp 7 may be controlled remotely, for example, to open and close the clamp as needed. In various embodiments, the absorber clamp 7 may include one or more sensors (e.g., proximity sensors, force sensors, optical sensors, camera-based sensors, tactile sensor, pressure sensor) configured to detect when the clamp is successfully closed around the metal root insert. The absorber clamp 7 may include a handle.

For example and without limitation, there may be any number of interlocks configured to prevent operation of system 100 until the at least one sensor within absorber clamp 7 is properly closed and secured to the metal root insert. In various embodiments, power to one or more actuating components, such as pistons (as will be described below) may be cut off until an electrical signal from the sensors with absorber clamp 7 are received. The absorber clamp 7 may include the one or more sensors for detecting proper closure to prevent misalignment of the metal root insert and potentially dangerous situations for the technician or operator. In various embodiments, the one or more sensors may include an optical or laser sensor configured to reflect a beam in order to detect presence and proper alignment of the metal root insert 104.

With continued reference to FIGS. 1-2D, system 100 may include one or more actuatable/reciprocating pistons 4. The piston 4 may be disposed underneath the bottom plate 1a of chassis 1 and configured to extend through an opening within the bottom plate 1a, extend upwardly parallel to the plurality of struts 1c, and further through a linear bearing 3 disposed within top cover 5. The piston 4 may be configured to actuate linearly parallel to the pillar 1b of chassis 1 and coaxially with the metal root insert. The piston 4 may include a cylinder that is aligned with the insert bottom rest 6 and configured to extend within the metal root insert to position the stopper within said metal root insert. In various embodiments, piston 4 may be configured to actuate from a rest position aligned with the top cover 5 to a second extended position at the optimal stopper location with metal root insert. The piston 4 may be affixed to the bottom plate 1a via one or more mechanical fasteners or one or more bearings, flanges or other geometrical retaining features.

In various embodiments, piston 4 may be configured to actuate under hydraulic, pneumatic or electrical power. For example and without limitation, one or more compressed gases, such as air may be supplied to the piston 4 in order to extend the piston and evacuated from the piston 4 in order to retract. Similarly, hydraulic oil may be supplied and evacuated from the piston 4 to affect the linear actuation. In various embodiments, one or more mechanical linkages, transmission boxes, rack and pinions or other mechanical drive trains may be employed to extend and retract the piston 4 into and from the metal root insert. For example and without limitation, in various embodiments the piston 4 may be at least partially formed by a FESTO-1383337 piston cylinder system.

With continued reference to FIGS. 1-2D, system 100 may include a metal rule 20 extending downward from the top cover 5 parallel to the piston within the plurality of struts 1c. In various embodiments the metal ruler 20 may demarcate increments of distance in order to assess the travel distance or instantaneous position of the piston 4. Metal ruler 20 may be configured to denote position in any units, such as inches or centimeters. System 100 may include markings (e.g., etched markings, printed parking, stamped markings) extending downward from the top cover 5 parallel to the piston within the plurality of struts 1c.

In various embodiments, system 100 may include a limit switch 15. Limit switch 15 may be adjustably coupled to the top cover 5 and pillar 1b of chassis 1 such as to adjustable hang underneath the top cover 5 proximate the piston 4. In various embodiments, the limit switch 15 may include an arm operatively coupled to the piston 4 such that actuation of the piston 4 is detected by the limit switch 15. In various embodiments, limit switch 15 may be adjustable coupled to top cover 5 by a crimping arm 22.

The crimping arm 22 may be a threaded rod configured to couple to both the top cover 5 and the limit switch 15. In various embodiments, rotation of the crimping arm 22 may affect adjustment of the limit switch 15 position relative to the top cover 5. In various embodiments, limit switch 15 may be configured to slide along a rail in order to provide rigidity and support and the crimping arm is rotated. For example, the limit switch 15 may be coupled to piston 4 at a rest position, upon actuation of the piston 4, the limit switch 15 may detect or measure the travel of the piston 4 and detect when an optimal end position of the piston 4 is reached. Additionally or alternatively, the system 100 may include proximity sensors, position sensors, laser distance sensors, or the like detect or measure the travel of the piston 4 and detect when an optimal end position of the piston 4 is reached. One or more components may be operatively coupled to the limit switch 15 such that when an optimal end position of the piston 4 is reached, the limit switch 15 may depower the piston 4 or reverse the actuation of the piston 4 in order to retract back to the rest position.

For example, and without limitation, the limit switch 15 may be operatively coupled to the absorber clamp 7 and one or more pumps in fluid communication with the piston 4. In various embodiments, the limit switch 15 may be electrically coupled to one or more audible indicators. In various embodiments, the limit switch 15 may be electrically coupled to one or more visual indicators such as colored lights (e.g., as shown in the view 24 in FIG. 2F). Limit switch 15 may be configured to illuminate the one or more lights in order to denote deficient or successful conditions related to the insertion of the stopper with metal root insert. For example, and without limitation, if the piston 4 is unable to reach the optimal end position with the metal root insert, the limit switch may be configured to illuminate a red warning light to indicate a failed condition of insertion. In various embodiments and oppositely, the limit switch 15 may be configured to illuminate a green light upon the piston 4 reaching the optimal end position, thus indicating a successful insertion of the stopper within the metal root insert. In various embodiments, the limit switch 15 may be adjusted to accommodate various client requirements for stopper insertion or metal root insert dimensions or optimal stopper positioning within said metal root insert.

In various embodiments, system 100 may be configured as a table top system, configured to be emplaced on a workbench or other suitable platform. In various embodiments, system 100 may be configured as a standalone system configured to be permanently affixed to its own platform. In various embodiments, the electronic components described hereinabove may be activated by a single push-button interaction by the technician or operator. In various embodiments, any number of mechanical, physical or electrical interactions from a user, operator or technician may be required to start, stop or adjust the parameters of the operation of system 100.

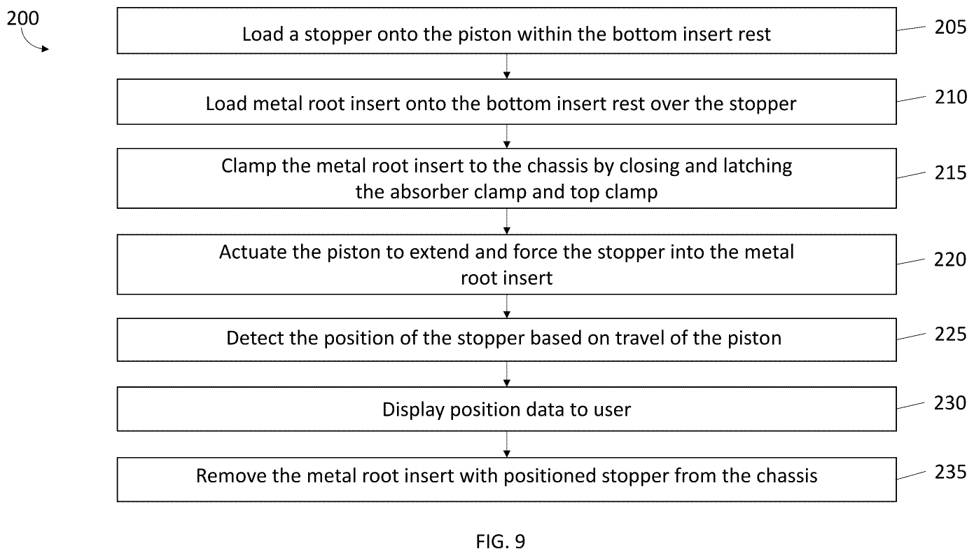

Referring now to FIG. 9, a method 200 for inserting a stopper into a metal root insert is shown in a flow diagram. The method 200 may be carried out by providing the system 100 as described herein above. Method 200 may include providing the system 100 in a table top or standalone configuration. Method 200 may include repeating one or more step of the method, or the entire method itself over any number of iterations in parallel or in sequence. For example and without limitation, the method 900 may be directed to inserting a single stopper into a single metal root insert, but may be equally applicable to inserting more than one stopper into a single metal root insert or a plurality of stoppers in a plurality of metal root inserts as necessary.

With continued reference to FIG. 9, method 200 includes, at step 205, loading a stopper onto the piston with the bottom insert rest. Loading the stopper 108 may include a technician manually placing a stopper in the proper orientation onto the piston that extends through the opening in the bottom insert rest. In various embodiments, the piston may be positioned below the bottom insert rest such that when the stopper is loaded, the piston comes in contact with the stopper as it is actuated upward. In various embodiments, the bottom insert rest may include one or more retaining or aligning features configured to removably couple the stopper 108 thereon until the piston comes into contact with said stopper. In various embodiments, the stopper may be seated in a recess within the bottom insert rest until the piston is actuated upward to carry the stopper into position within the metal root insert. In various embodiments, one or more sensors may be configured to detect stopper placement on the bottom insert rest, or proper positioning. In various embodiments, these one or more sensors may be configured to arrest power to any component as described herein until the stopper is properly aligned and seated on the bottom insert rest.

With continued reference to FIG. 9, method 200 includes, at step 210, loading the metal root insert onto the bottom insert rest and over the stopper emplaced thereon. The hollow interior of the metal root insert may fully envelope the stopper and any aligning features of the bottom insert rest to ensure proper alignment and full seating of the metal root insert on the bottom insert rest. In various embodiments, the metal root insert may be manually loaded into system 100 or may be automatedly loaded, such as from a hopper, magazine, or pick and placed by one or more robotic arms. In various embodiments, the end of the metal root insert may be placed on the bottom insert rest, pressed downward and fully seated onto said metal root insert and leaned toward the chassis pillar 1b against the bearings, as will be discussed below. In various embodiments, one or more sensors may be disposed within system 100 and employed in method 200 to detect the metal root insert is loaded and/or properly aligned on the bottom insert rest over the stopper.

With continued reference to FIG. 9, method 200, includes, at step 215, clamping the metal root insert to the chassis 1 by closing and lathing the absorber clamp 7 and top clamp 11. In various embodiments, clamping the top clamp 11 may include rotating the top clamp 11 from a first position out of alignment with the top end of the metal root insert to a clamping position axially aligned with the metal root insert 104. In various embodiments, the top clamp 11 is then closed over the top end of the metal root insert 104 by lowering lever 13 to a closed and locked position. In various embodiments, the length of travel of top clamp 11 may be adjusted in order to properly compress the metal root insert against the bottom insert rest. In various embodiments, clamping the top clamp 11 may include adjusting the thickness of polyurethane bearing 14 to ensure a proper fit with the metal root insert. In various embodiments, clamping the absorber clamp 7 may include wrapping or closing the absorber clamp 7 about the cylindrical sidewall of the metal root insert and latching the absorber clamp 7 in the closed position. In various embodiments, clamping the absorber clamp 7 may include detecting proper alignment and proper closure of the clamp. In various embodiments, one or more sensors may be disposed within absorber clamp 7 and provide one or more electrical signals to initiate power to an electrical component, such as a pump in fluid communication with the piston 4 in order to provide power for insertion of the stopper in the metal root insert. For example and without limitation, the one or more sensors may visually indicate alignment of the metal root insert and proper closure of the absorber clamp 7 via a light, for example illuminating a red light to indicate improper alignment/closure and illuminating a green light to indicate proper alignment/closure. In various embodiments, notification of alignment may be provided visually, audibly or in a tactile manner. In various embodiments, one or more interlocks may prevent operation of system 100 and therefore method 200 without proper alignment and latching of the absorber clamp 7.

With continued reference to FIG. 9, method 200 includes, at step 220, actuating the piston to extend and force the stopper 108 into the metal root insert 104. In various embodiments, the piston 4 may travel from a rest position external to the metal root insert 104 to a position interior to the metal root insert 104. In various embodiments, the rest position of the piston 4 may already be internal to the metal root insert 104, for example, when the metal root insert is loaded onto the bottom insert rest 6, the piston 4 may extend partially within the interior hollow portion metal root insert 104.

Actuating the piston 4 may include providing pneumatic, hydraulic or mechanical power to the piston 4 to affect extension of the piston's cylinder. In various embodiments, the piston 4 may be axially coupled to one or more further cylinders extending axially within the metal root insert 4. For example and without limitation, the piston 4 may extend under pneumatic or hydraulic power, thereby forcing a cylinder upwards, said cylinder forcing the stopper 108 into the metal root insert 104. In various embodiments, the piston 4 may be actuated in a continuous motion from a rest position to a final position. In various embodiments, the piston 4 may be actuated in steps, advancing the stopper 108 within the metal root insert 104 in discrete lengths. For example and without limitation, there may be any number or iterations of actuation of the piston 4 to properly force the stopper 108 into the metal root insert 104. In various embodiments, a first actuation of the piston 4 may lodge the stopper 108 within the metal root insert 104, and a second actuation of the piston 4 may advance the stopper 108 to its final position within the metal root insert 104.

With continued reference to FIG. 9, method 200 includes, at step 225, detecting the position of the stopper 108 based on travel of the piston 4. In various embodiments, the limit switch 15 may be zeroed at the rest position of the piston 4, and configured to detect the travel of the piston 4 within the metal root insert 104. The limit switch 15 may be configured to power or depower the piston 4 based on the position thereof. For example, the limit switch 15 may depower the piston 4 until it is reset to its rest position external to the metal root insert 104. Further, the limit switch 15 may depower or reverse the piston 4 when the final position of the stopper 108 is reached according to a predetermined travel distance of the piston 4. The limit switch 15 may be set to a predetermined travel length, such that various stopper 108 positions can be accomplished with a single piston 4 according to client specifications. Limit switch 15 may be physically lowered and raised relative to the top cover 5 to adjust the length of travel of piston 4 the limit switch 15 allows for.

With continued reference to FIG. 9, method 200 includes, at step 230, displaying position data to the user. In various embodiments, displaying position date to the user may include displaying a binary indication of proper stopper 108 within metal root insert 104. For example and without limitation, displaying a successful stopper 108 positioning within the metal root insert 104 may include a green light to the user or technician. In various embodiments, displaying position data to the user may include displaying a distance to the user or technician, for example a length in inches the stopper 108 is placed from the end of the metal root insert 104. In various embodiments, displaying position data to the user may include displaying an unsuccessful positioning of the stopper 108, such as by displaying a red light or length readout identifying the stopper 108 was not placed in the predetermined position within the metal root insert 104.

With continued reference to FIG. 9, method 200 includes, at step 235, removing the metal root insert 104 with the positioned inserted stopper 108 from the system 100. Removing the metal root insert 104 may be performed manually by the user/technician by unclamping the absorber clamp 7 and top clamp 11. In various embodiments, the piston 4 may retreat from within the metal root insert 104 automatically upon detection of proper stopper 108 placement or may be manually retracted by the user or technician. In various embodiments, removing the metal root insert 104 may include raising the metal root insert 104 out of the system 100 thus manually clearing the piston 4 from within the metal root insert 104. In various embodiments, one or more ejector pins or actuators may be configured to push the metal root insert 104 up and/or out of the system 100 after detection of proper stopper 108 placement. In various embodiments, one or more automated components such as robotic arms may be configured to both unclamp the absorber clamp 7, top clamp 11 and remove the metal root insert 104 from chassis 1. Additionally or alternatively to the various clamps 7, 11, etc. these components can be augmented, or replaced, with magnetic couplings to hold the root insert in position during insertion of the stopper. In various embodiments, further alignment checks can be performed via one or more automated or manual operations. For example and without limitation, a user may utilize a ruler or internal measurement component having the optimal stopper position marked thereon for visual inspection of the stopper 108.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A system for inserting a stopper in a metal root insert, the system comprising:
a chassis, the chassis having a bottom plate having a first end and a second end, defining a length therebetween, the chassis having generally planar a top surface and a bottom surface defining a thickness therebetween, the chassis further having
a pillar having a first end disposed on the first side of the top surface of the bottom plate and extending perpendicularly therefrom to a second end;
at least one strut having a first end disposed on the second side of the top surface of the bottom plate and extending perpendicularly therefrom to a second end;
a top cover disposed at the second end of the at least one strut, the top cover disposed perpendicularly to the bottom plate;
an absorber clamp disposed on the pillar, the absorber clamp extending perpendicular to the pillar, the absorber clamp having a circular bearing configured to hingedly close;
a top clamp disposed at the second end of the pillar, the top clamp having a cylindrical bearing configured to vertically translate relative to the top clamp;
a piston disposed below the top cover, the piston configured to translate vertically through at least one of the bottom plate and the top cover; and
a limit switch operatively coupled to piston, the limit switch configured to detect a travel of the piston.

2. The system of claim 1, wherein the top cover further comprises a bottom insert rest disposed on a top surface thereof, the bottom insert rest having a cylindrical alignment feature.

3. The system of claim 1, wherein the absorber clamp comprises at least one sensor.

4. The system of claim 3, wherein the at least one sensor is configured to detect the presence of a metal root insert.

5. The system of claim 3, wherein the at least one sensor is configured to detect closure of the absorber clamp.

6. The system of claim 1, wherein the chassis further comprises an alignment bearing, the alignment bearing extending from the pillar and having a semicircular bearing configured to contact a cylindrical sidewall of the metal root insert.

7. The system of claim 1, wherein the metal root insert comprises a first end and a second end with a cylindrical sidewall extending therebetween, the metal root insert further comprising an outer diameter and an inner diameter, defining a cylindrical thickness therebetween.

8. The system of claim 1, wherein the at least one strut comprises four struts, the four struts equiaxially spaced proximate the second end of the bottom plate, the at least four struts each having a first end disposed on the top surface of the bottom plate and a second end disposed on a bottom surface of the top cover.

9. The system of claim 1, wherein the bottom plate comprises an opening extending from the bottom surface to the top surface, the opening sized to receive the piston.

10. The system of claim 9, wherein the top cover comprises an opening axially aligned with the opening in the bottom plate, the opening in the top cover extending through the bottom insert rest.

11. The system of claim 7, wherein the stopper comprises a first end and a second end, with a cylindrical sidewall therebetween, the stopper further comprising an outer diameter approximately equal to the inner diameter of the metal root insert.

12. The system of claim 8, wherein the stopper is formed from a plastic material.

13. The system of claim 7, wherein the metal root insert is formed from one or more metals or metal alloys.

14. The system of claim 13, wherein the metal root insert is formed from steel.

15. A method for inserting a stopper in a metal root insert, the method comprising:
loading a stopper onto a piston circumscribed by a bottom insert rest;
loading a first end of a metal root insert onto a bottom insert rest over the stopper such that the stopper is disposed within a hollow interior of the first end of the metal root insert;
clamping the metal root insert to a chassis pillar, wherein clamping the metal root insert comprises closing and latching an absorber clamp about a cylindrical sidewall of the metal root insert and closing a top clamp over a second end of the metal root insert;
actuating the piston having the stopper to a position within the hollow interior of the metal root insert;
detecting the position of the stopper based on a travel of the piston;
displaying a position datum of the stopper; and
removing the metal root insert within the positioned stopper from the chassis.

16. The method of claim 15, wherein detecting the position of the stopper based on a travel of the piston comprises detecting the travel between a rest position of the piston and an end position of the piston.

17. The method of claim 15, wherein displaying the position datum of the stopper comprises illuminating at least one light source.

18. The method of claim 17, wherein illuminating the at least one light source comprises illuminating at least one light source to display a proper positioning of the stopper within the metal root insert.

19. The method of claim 15, wherein displaying a position datum comprises producing an audible signal to a user.

20. The method of claim 15, wherein removing the metal root insert comprises retracting the piston from within the metal root insert.
